(19) United States
(12) Patent Application Publication
(10) Pub. No.: US 2017/0077773 A1
(43) Pub. Date: Mar. 16, 2017

(54) PERMANENT MAGNET MOTOR AND POWER TOOL USING SAME

(71) Applicant: Johnson Electric S.A., Murten (CH)

(72) Inventors: Yue LI, Hong Kong (CN); Chui You ZHOU, Shenzhen (CN); Kwong Yip POON, Hong Kong (CN); Ronny KEIL, Shenzhen (CN); Yong WANG, Shenzhen (CN); Xiao Ning ZHU, Shenzhen (CN)

(21) Appl. No.: 15/260,772

(22) Filed: Sep. 9, 2016

(30) Foreign Application Priority Data
Sep. 11, 2015 (CN) 2015 1058 0299.7
Jun. 13, 2016 (CN) 2016 1041 6278.6

(51) Int. Cl. H02K 1/27; B23D 57/02; H02K 21/22; H02K 1/14; H02K 3/18

(52) U.S. Cl. CPC H02K 1/2786; H02K 1/146; H02K 3/18; H02K 21/22; B23D 57/02; H02K 2213/03

(57) ABSTRACT

A permanent magnet motor and a power tool are provided. The permanent magnet motor includes an excition and an armature. One of the excition and armature comprises a first magnetic core with permanent magnet members embedded therein. The permanent magnet members are arranged along a circumferential direction of the first magnetic core, such that an inner circumferential surface of the first magnetic core forms a plurality of magnetic poles with alternative polarities. The other of the excition and armature comprises a second magnetic core and windings. The second magnetic core is received in the first magnetic core and comprises teeth with the windings wound therearound. The embedded construction prevents the permanent magnet members from becoming disengaged from the magnetic core. A stronger magnetic pole can be formed by mutual induction of the permanent magnet members and the magnetic core, which increases the power density of the motor.

### CROSS REFERENCE TO RELATED APPLICATIONS

This non-provisional patent application claims priority under 35 U.S.C. §119(a) from Patent Application No 201510580299.7 and 201610416278.6, respectively filed in The People's Republic of China on Sep. 11, 2015, and Jun. 13, 2016.

### FIELD OF THE INVENTION

The present invention relates to motors, and in particular to a permanent magnet motor which is particularly suitable for use in a power tool such as a power saw.

### BACKGROUND OF THE INVENTION

Permanent magnet motors typically include an excition and an atmature. The excition includes a ring shaped outer housing, a plurality of permanent magnet members mounted to an inner circumferential surface of the outer housing, and an end cover mounted an axial end of the outer housing. The armature includes a rotary shaft, an armature core fixed to the rotary shaft, and windings wound around teeth of the armature core. A bearing is mounted to the end cover for supporting the rotary shaft of the armature, such that the armature is capable of rotation relative to the excition. Another shortcoming of the conventional motor is that the motor has a low power density and permanent magnet members may become disengaged from the armature core which would cause malfunction of the motor. In addition, a greater power density of the motor is desired.

### SUMMARY OF THE INVENTION

In one aspect, the present invention provides a permanent magnet motor and a power tool with the permanent magnet motor mounted therein. The permanent magnet motor includes an excition and an armature rotatably relative to each other. One of the excition and armature includes a ring shaped first magnetic core and a plurality of permanent magnet members embedded in the first magnetic core. The plurality of permanent magnet members is arrayed along a circumferential direction of the first magnetic core, such that an inner circumferential surface of the first magnetic core forms a plurality of magnetic poles with alternative polarities. The other of the excition and armature includes a second magnetic core and windings. The second magnetic core is received in the first magnetic core and comprises a plurality of teeth extending toward the first magnetic core, and the windings are wound around the teeth.

In the permanent magnet motor of the present invention, the permanent magnet members are embedded into the magnetic core, which prevents the permanent magnet members from becoming disengaged from the magnetic core. In addition, a stronger magnetic pole can be formed by mutual induction of the permanent magnet members and the magnetic core, which increases the power density of the motor. This permanent magnet motor is suitable for various power tools including, but not limited to, a power saw.

one of the excition and armature comprises a ring shaped first magnetic core and a plurality of permanent magnet members embedded in the first magnetic core, the plurality of permanent magnet members is arrayed along a circumferential direction of the first magnetic core, such that an inner circumferential surface of the first magnetic core forms a plurality of magnetic poles 58 with alternative polarities;

the other of the excition and armature comprises a second magnetic core, the second magnetic core is surrounded by the first magnetic core and comprises a plurality of teeth extending toward the first magnetic core.

### BRIEF DESCRIPTION OF THE DRAWINGS

FIG. 1 is a block diagram of a structure of a power tool of the present invention.

FIG. 2 is a sectional view of a permanent magnet motor according to a first embodiment of the present invention.

FIG. 3 is a sectional view of a permanent magnet motor according to a second embodiment of the present invention.

FIG. 4 is a sectional view of a permanent magnet motor according to a third embodiment of the present invention.

FIG. 5 illustrates one way to form an uneven air gap of the permanent magnet motor of the present invention.

FIG. 6 illustrates another way to form the uneven air gap of the permanent magnet motor of the present invention.

### DETAILED DESCRIPTION OF THE PREFERRED EMBODIMENTS

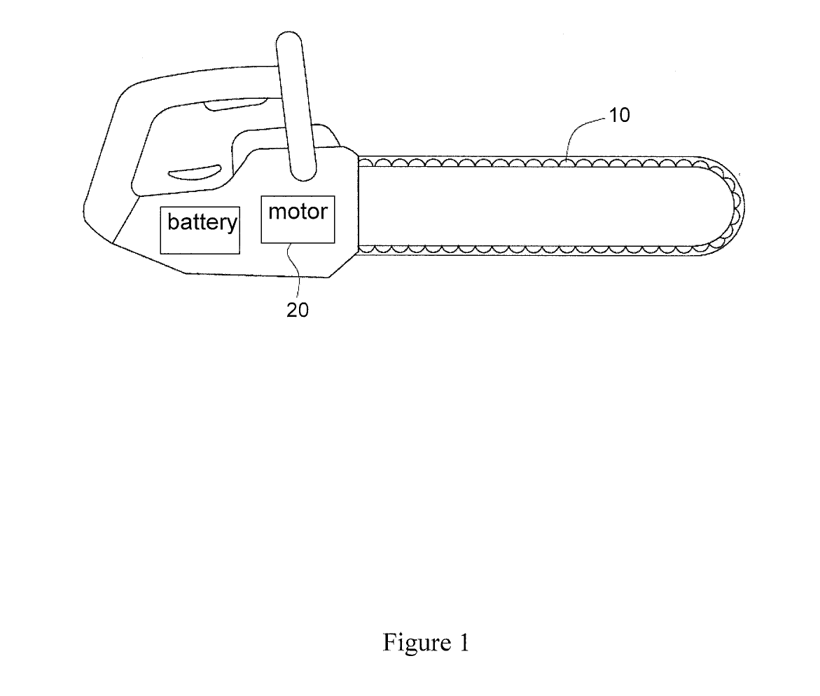

Referring to FIG. 1, the power tool according to one embodiment of the present invention is a power saw which includes a permanent magnet motor 20 and a saw blade 10. The permanent magnet motor 20 drives the saw blade 10 to move through a transmission mechanism such as a speed reduction mechanism. The present invention mainly improves the motor, the power saw may be constructed as a known power raw and, therefore, the detailed structure of the power saw is not described herein.

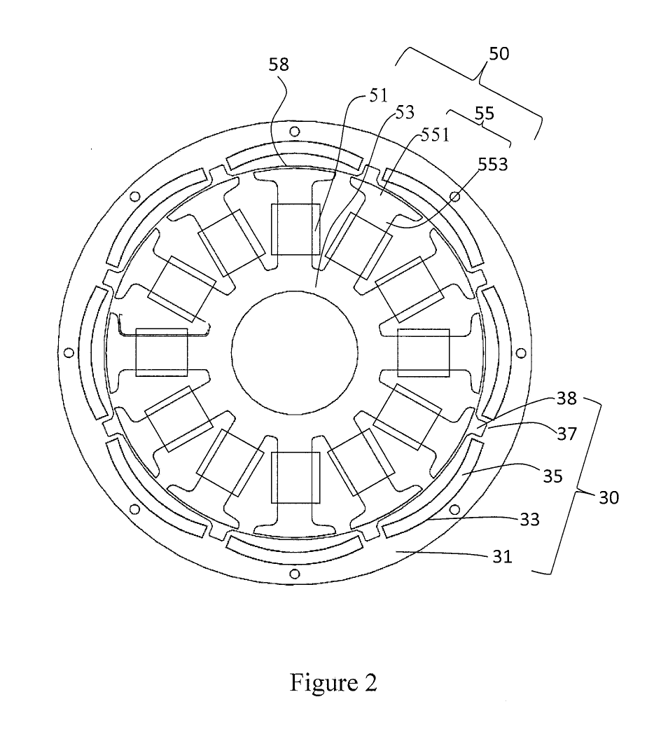

Referring to FIG. 2, the permanent magnet motor 20 in accordance with a first embodiment of the present invention includes an excition 30 and an armature 50. The excition 30 includes a ring shaped first magnetic core 31 and a plurality of permanent magnet members 35 embedded into the first magnetic core 31 along an axial direction of the motor. The armature 50 includes a second magnetic core 53. The second magnetic core 53 includes a plurality of teeth 55. Each tooth 55 includes a tooth body 553 around which a winding 51 is wound and a pole shoe 551 formed at a distal end of the tooth body 553. The second magnetic core 53 is surrounded by the first magnetic core 31.

The first magnetic core 31 may be formed by a plurality of silicon steel sheets stacked along the axial direction of the motor. Each silicon steel sheet define with a mounting hole 33 for embedding the permanent magnet member 35 therein after the silicon steel sheets are stacked. Preferably, each permanent magnet member 35 is circular-arc shaped, and a depressing side of the arc faces the second magnetic core 53. It should be understood that each permanent magnet member 35 may also be flat-plate shaped with a uniform or non-uniform thickness so as to be embedded into the first magnetic core 31. The permanent magnet member 35 is embedded into an interior of the magnetic core, which avoids or reduces the risk of the permanent magnet member 35 becoming disengaged from the magnetic core.

In the first embodiment, each permanent magnet member 35 is a integrally formed part and polarized along a radius direction of the first magnetic core 31. In this embodiment, each permanent magnet member 35 forms a single one magnetic pole 58, and the adjacent each permanent magnet member 35 have opposite polarities. The permanent magnet members 35 are arrayed along a circumferential direction of the first magnetic core 31, and the polarities of inner surfaces of the permanent magnet members 35 are in an alternative arrangement of N and S polarities, such that a plurality of alternatively arranged N and S polarities are formed along an inner circumferential surface of the first magnetic core 31. It should be understood that, in another embodiment, each permanent magnet member 35 may also be construed by multiple permanent magnet blocks By utilizing the embedded processing, the multiple permanent magnet blocks are pieced together to form a bigger-sized permanent magnet member 35 to increases the power density of the motor and hence enhances the performance and efficiency of the motor.

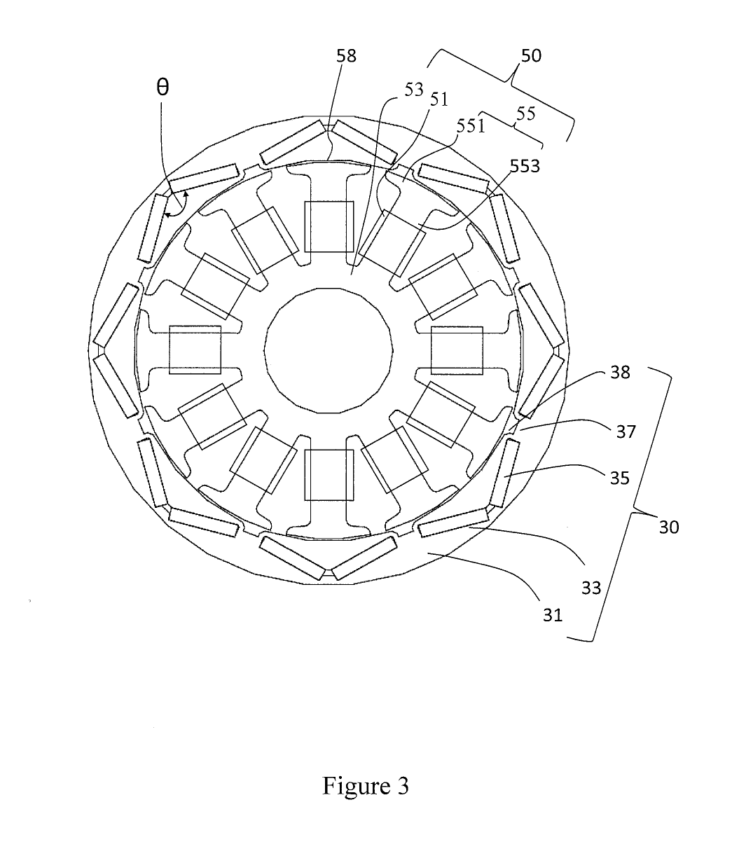

Referring to FIG. 3, a permanent magnet motor in accordance with a second embodiment of the present invention differs from the first embodiment mainly in the quantity, shape and positions of the permanent magnet members 35. In particular, the permanent magnet members 35 embedded into the first magnetic core 31 is twice as many as the magnetic poles 58. In other words, each two permanent magnet members 35 forms one magnetic pole 58 at the inner circumferential surface of the first magnetic core 31. The two permanent magnet members 35 cooperatively shape a “V”, and an angle θ of the “V” is equal to or greater than 90° and equal to or less than 170°. The “V” has an opening facing the second magnetic core 53, and the inner surfaces of the two permanent magnet members 35 facing the second core 53 have the same polarities, such that the inner circumferential surface of the first magnetic core 31 corresponding to the opening of the “V” can be magnetized to form one of the magnetic poles 58. The magnetic pole 58 of the excition 30 as configured above can achieve magnetic flux concentration effect. In order to improve magnetic flux concentration effect, make the best use of space and increase the power density, the range of the angle θ is preferably 120°≦θ≦170°, or more preferably, 120°≦θ≦150°.

In the second embodiment, each permanent magnet member 35 is flat-plate shaped. It should be understood that the permanent magnet member 35 may also be arc shaped or oval shaped with a thick middle and two thin ends.

In the second embodiment, each two permanent magnet members 35 corporately form one magnetic pole 58 at the inner circumferential surface of the first magnetic core 31. It should be understood that, in another embodiment, each magnetic pole 58 may also be formed by three or more permanent magnetic members 35.

Therefore, the permanent magnet members 35 embedded into the first magnetic core 31 is n times as many as the magnetic poles 58 in quantity, where n is an integer greater than 0.

Referring to FIG. 2 and FIG. 3, in the first and second embodiments, the inner surface of the first magnetic core 31 forms a cut 37 between each two adjacent magnetic poles 58, and forms a magnetic bridge 38 near each cut 37, such that the magnetic bridges 38 are arranged along the circumferential direction of the motor and each magnetic bridge 38 is disposed between each two corresponding adjacent magnetic poles 58. The magnetic bridge 38 has a very large magnetic reluctance, which can reduce or prevent the pass of the magnetic flux through this magnetic bridge 38, such that the magnetic flux produced by the permanent magnet members 35 enters the second magnetic core 51 through the first magnetic core 31 as much as possible to further improve the motor performance.

In the first and second embodiment, a radial depth of the cut 37 is about ⅓ of a radial thickness of the first magnetic core 31. The radial depth of the cut 37 should be in the range of ⅕ to ⅔ of the radial thickness of the first magnetic core 31.

In the first and second embodiment, the cut 37 extends continuously along the axial direction of the motor. Alternatively, the cut 37 is discontinuous along the axial direction of the motor. That is, one magnetic bridge is defined by multiple cuts spaced apart along the axial direction of the motor.

Preferably, the inner circumferential surface of the first magnetic core 31, except at the magnetic bridges, is located on a same circle in an axial plan view. In other words, the magnetic poles 58 formed on the first magnetic core 31 are located at same circumferential surface. As such, an even air gap is formed between the magnetic poles 58 of the excition 30 and the pole shoes 551 of the second magnetic core 53. It is understood that even air gap contributes to a simplified motor structure and facilitates fabrication thereof

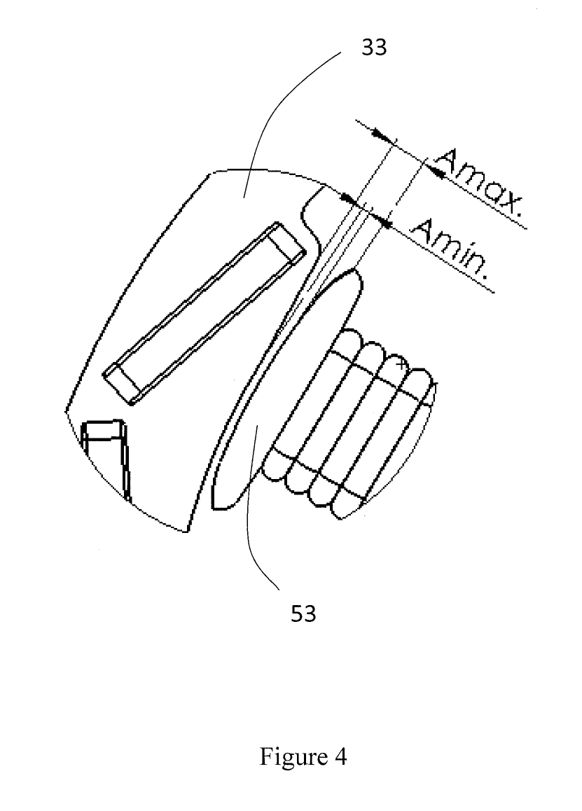

Referring to FIG. 4, in the third embodiment, uneven air gaps are formed between the magnetic poles 58 of the excition 30 and the pole shoes 551 of the second magnetic core 53. A radio of a maximum thickness Amax of the air gap to a minimum thickness Amin of the air gap is less than or equal to four. The uneven air gaps can effectively reduce the cogging torque and hence reducing the noise in operation of the motor. It should be understood that the air gaps can be symmetrical and uneven if a bidirectional startup capability of the motor is desired. That is, when the pole shoes 551 of one of the teeth 55 of the second magnetic core 53 is aligned with one of the magnetic poles 58 of the first magnetic core 31, the air gap between the pole shoe 551 and the magnetic pole 58 is symmetrical about a center line of the pole body 553 of the tooth 55. The center line refers to a line connecting between a circumferential center point of the magnetic pole and a rotation axis of the motor. On the contrary, if a single direction startup capability of the motor is desired, the air gap can be an asymmetric and uneven.

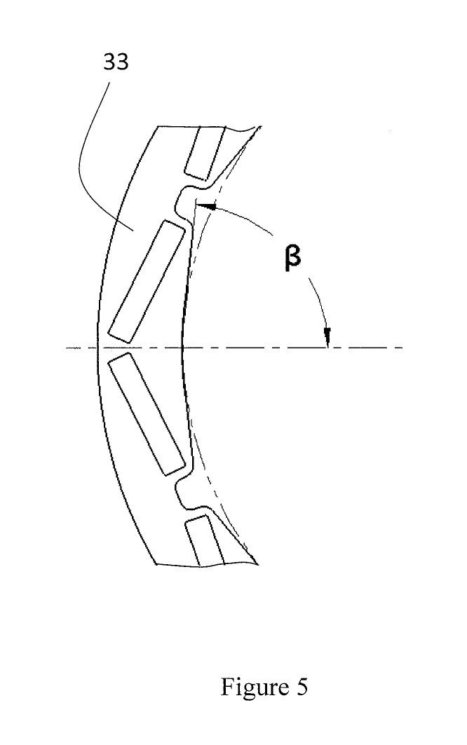

Referring to FIG. 5, in one embodiment, to form the uneven air gap, a cutting plane is formed on the inner circumferential surface of the first magnetic core 31 corresponding to one or two ends of each magnetic pole. An angle β is formed between the cutting plane and the center line of the corresponding magnetic pole. The angle β is equal to or greater than 60° and equal to or less than 100° and, preferably, equal to or greater than 70° and equal to or less than 90°.

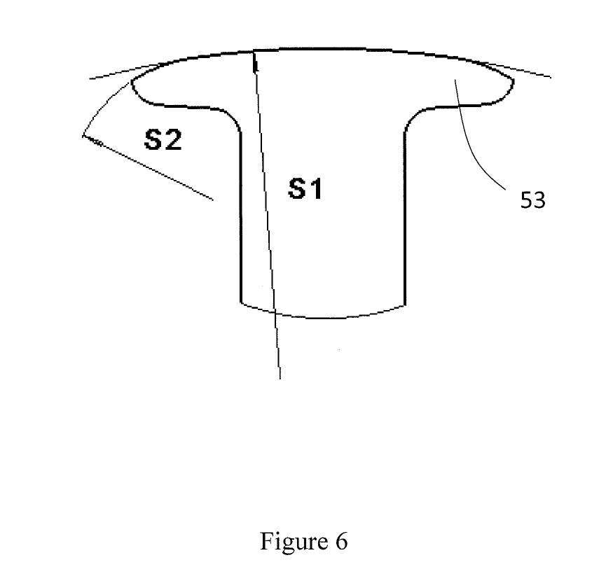

Referring to FIG. 6, in another embodiment, a cutting surface is formed on one or two ends of an outer side of each pole shoe 551 of the second magnetic core 53. The cutting surface 551 may be an arc surface S2, and a middle portion of the outer side of the pole shoe 551 is an arc surface S1. The arc surface S1 and the arc surface S2 are tangential with each other, and a curvature of the arc surface S1 is less than a curvature of the arc surface S2.

In the above embodiments, the motor is an outer rotor brushless motor, the first magnetic core 31 and the permanent magnet members 35 act as the rotor of the motor, and the second magnetic core 53 and the windings 51 on the second magnetic core 53 act as the stator of the motor. It should be understood that the first core 31 and the permanent magnet members 35 may also act as the stator of the motor, and the second magnetic core 53 and the windings 51 on the second magnetic core 53 may act as the rotor of the motor. In this case, the motor is an inner rotor motor. The motor may be single phase motor or three phase motor according to various connection pattern of the winding 51.

Although the invention is described with reference to one or more preferred embodiments, it should be appreciated by those skilled in the art that various modifications are possible. Therefore, the scope of the invention is to be determined by reference to the claims that follow.

1. A permanent magnet motor comprising an excition and an armature rotatably relative to each other, wherein:
one of the excition and armature comprises a ring shaped first magnetic core and a plurality of permanent magnet members embedded in the first magnetic core, the plurality of permanent magnet members is arrayed along a circumferential direction of the first magnetic core, such that an inner circumferential surface of the first magnetic core forms a plurality of magnetic poles 58 with alternative polarities;
the other of the excition and armature comprises a second magnetic core, the second magnetic core is surrounded by the first magnetic core and comprises a plurality of teeth extending toward the first magnetic core.

2. The permanent magnet motor of claim 1, wherein the excition is a stator of the motor, and the armature is a rotor of the motor.

3. The permanent magnet motor of claim 1, wherein the first magnetic core comprises a plurality of magnetic bridges arrayed along the circumferential direction of the motor, and each magnetic bridge is located between two corresponding adjacent magnetic poles.

4. The permanent magnet motor of claim 3, wherein the first magnetic core forms a cut corresponding to each magnetic bridge.

5. The permanent magnet motor of claim 4, wherein the cut is formed in an inner surface of the first magnetic core, and a ratio of a radial depth of each cut to a radial thickness of the first magnetic core is greater than zero and less than or equal to ⅔.

6. The permanent magnet motor of claim 1, wherein the magnetic poles formed on the first magnetic core are located at same circumferential surface.

7. The permanent magnet motor of claim 1, wherein the permanent magnet members embedded into the first magnetic core is n times as many as the magnetic poles in quantity, where n is an integer greater than 0, each n permanent magnet members form one magnetic pole at the inner circumferential surface of the first magnetic core.

8. The permanent magnet motor of claim 7, the each permanent magnet member is circular-arc shaped, and an depressing side of the circular arc faces the second magnetic core.

9. The permanent magnet motor of claim 7, wherein each permanent magnet member is flat-plate shaped, arc shaped or oval shaped with a thick middle and two thin ends.

10. The permanent magnet motor (20) of claim 9, wherein n is equal to 2, each two permanent magnet members (35) form one magnetic pole at the inner circumferential surface of the first magnetic core (31), the two permanent magnet members (35) cooperatively shape a “V”, an opening of the “V” faces the second magnetic core (53), and an angle θ of the “V” is equal to or greater than 90° and less than or equal to 170°.

11. The permanent magnet motor of claim 10, wherein the range of the angle θ is 120°≦θ≦170°.

12. The permanent magnet motor of claim 11, wherein the range of the angle θ is 120°≦θ≦150°.

13. The permanent magnet motor of claim 1, wherein an uneven air gap is defined between the magnetic poles of the first magnetic core and the pole shoes of the second magnetic core, a radio of a maximum thickness Amax of the air gap thickness to a minimum thickness Amin of the air gap is less than or equal to four.

14. The permanent magnet motor of claim 13, wherein the air gap is symmetrical or asymmetric about a center line of the magnetic pole.

15. The permanent magnet motor of claim 13, wherein a cutting plane is formed on the inner circumferential surface of the first magnetic core corresponding to one or two ends of each magnetic pole, the cutting plane and the center line of one corresponding magnetic pole form an angle β therebetween, and the angle β is equal to or greater than 60° and equal to or less than 100°.

16. The permanent magnet motor of claim 15, wherein the angle β is equal to or greater than 70° and equal to or less than 90°.

17. The permanent magnet motor of claim 13, wherein a cutting surface is formed on one or two ends of an outer side of each pole shoe of the second magnetic core.

18. The permanent magnet motor of claim 17, wherein the cutting surface is an arc surface S2, and a middle portion of the outer side of the pole shoe is an arc surface S1, the arc surface S1 and the arc surface S2 are tangential with each other, and a curvature of the arc surface S1 is less than a curvature of the arc surface S2.

19. A power tool comprises a permanent magnet motor, the permanent magnet motor comprising an excition and an armature rotatably mounted to the excition, wherein:
one of the excition and armature comprises a ring shaped first magnetic core and a plurality of permanent magnet members embedded into the first magnetic core, the plurality of permanent magnet members is arrayed along a circumferential direction of the first magnetic core, such that an inner circumferential surface of the first magnetic core forms a plurality of magnetic poles with alternative polarities; and
the other of the excition and armature comprises a second magnetic core and windings, the second magnetic core is received in the first magnetic core and comprises a plurality of teeth extending toward the first magnetic core, and the windings are wound around the teeth.

20. The power tool of claim 19, wherein the power tool is a power saw comprising a saw blade, and the permanent magnet motor is configured to drive the saw blade.
